(19) United States
(12) Patent Application Publication
(10) Pub. No.: US 2014/0194328 A1
(43) Pub. Date: Jul. 10, 2014

(54) THERMOSET CERAMIC COMPOSITIONS AND A METHOD OF PREPARATION THEREFOR

(71) Applicant: Vince Alessi, Ann Arbor, MI (US)

(72) Inventor: Vince Alessi, Ann Arbor, MI (US)

(21) Appl. No.: 13/832,328

(22) Filed: Mar. 15, 2013

Related U.S. Application Data
(60) Provisional application No. 61/749,417, filed on Jan. 7, 2013.

(51) Int. Cl. C09K 8/80

(52) U.S. Cl. CPC C09K 8/80
USPC 507/269; 423/327.1

(57) ABSTRACT

Thermoset ceramic compositions and a method of preparation of such compositions. The compositions are advanced organic/inorganic hybrid composite polymer ceramic alloys. The material combine strength, hardness and high temperature performance of technical ceramics with the strength, ductility, thermal shock resistance, density, and easy processing of the polymer. Consisting of a branched backbone of silicon, alumina, and carbon, the material undergoes sintering at 7 to 300 centigrade for 2 to 94 hours from water at a pH between 0 to 14, humidity of 0 to 100%, with or without vaporous solvents.

This application claims priority from U.S. Provisional application Ser. No. 61/749,417, filed Jan. 7, 2013, pending.

### BACKGROUND OF THE INVENTION

What has been discovered are new compositions of matter and novel methods of preparing such compositions.

The material is a family of advanced organic/inorganic hybrid composite polymer ceramics (HCPC's). Materials that are currently used in the art today include those found in “Modified Geopolymer Composition, Processes and Uses, disclosed in EP 2438027 A2, “Composition for Sustained Drug Delivery Comprising Geopolymeric Binder, disclosed in U.S. Patent publication 2012/0252845 A1. AlC/Al₂O₃ Composites That Are Sintered Bodies and Method of Producing the Same” is disclosed in EP 0311289 B1. In addition, others have been disclosed in “Geopolymer Composition and Application in Oilfield Industry, U.S. Pat. No. 7,794,537; “A Novel Carbonated Calcium Aluminosilicate Material for the Removal of Metals From Aqueous Waste Streams, Sixth International Water Technology Conference, IWTC 2001, Alexandria, Egypt; U.S. Patent publication 2011/0230339, U.S. Pat. No. 5,866,754; U.S. Pat. No. 5,284,513; U.S. Pat. No. 8,257,486; U.S. Pat. No. 7,655,202, U.S. Pat. No. 7,846,250, and U.S. Pat. No. 5,601,643. The compositions of this invention were not found in the prior art. In addition, the preparation processes were also not found in the prior art.

### THE INVENTION

Thus, what is disclosed and claimed herein in one embodiment, is a composition of matter comprising a polymer of aluminum, silicon, carbon, and oxygen.

In another embodiment, there is a composition of matter provided by the incipient materials aluminum oxide, silicon oxide, carbon, and, a source of divalent cations.

Yet, another embodiment is a composition of matter as set forth just Supra, which is a gel.

Still another embodiment is a method of preparation of a composition wherein the method comprises providing a mixture of aluminum oxide and silicon oxide and, providing a second mixture, having a basic pH, in a slurry form, of water, a source of 0H, carbon, and, a source of divalent cations.

Thereafter, mixing the materials together using shear force to form a stiff gel and thereafter, exposing the resulting product to a temperature in the range of 160° F. to 250° F. for a period of time to provide a thermoset ceramic.

### BRIEF DESCRIPTION OF THE DRAWINGS

FIG. 1 is Raman peak at 1349 wave numbers (cm⁻¹) has a full width half height ratio of 0.12.

FIG. 2 is Raman peak at 1323 wave numbers (cm⁻¹) full width half height ratio is 0.16.

### DETAILED DISCUSSION OF THE INVENTION

The present invention is unique from existing prior art in both its fundamental composition of matter, and perhaps more notably, its mechanism of synthesis. The reaction pathway by which the material is obtained proceeds through first, the dissolution of the amorphous silicon, alumina, carbon, and alkali metal, in an alkaline solution co-solvated with one or more polar aprotic or protic solvents.

The resulting solution/slurry rapidly has a viscosity between 1000 and 700,000 centipoise. This solution hardens into a gel-state as a result of silanol condensation complimented by cationic stabilization of the free labile anionic network forming elements (Al, Si, O, C). The physical properties of this gel state, and the states immediately preceding it, are largely a function of the concentration of divalent cations: monovalent cations: to network forming elements (Al, Si, O, C).

This gel is stable for a time period of several minutes to several months, after which it will undergo dehydration-mediated shrinkage and cracking. The gel state can then be subjected to curing at elevated temperatures and humidity, consisting of various pH water and solvents, at various pressures. During this curing, the reactivity of the system increases as solvolysis of the gel system recuperates alkalinity of the system, re-dissolving the silanol condensation product to a greater or lesser extent, and mediating a complete amorphous structure formation of the network forming elements (Al, Si, O, C).

The added heat of the system overcomes the endothermic barrier preventing the network forming reactions from taking place previously. Al and Si are bound via bridging oxygen generated via hydrolysis, which consumes alkalinity of the gel, and C—Si, Si—C—Si and potentially metastable Al—C, bonds are formed. The fundamental monomer of the reaction may be any variation of O, Al, C, and Si, e.g. Al—O—Si—C—Si—O—Al—O. More monocationic species will lead to a more polymeric and generally weaker structure, whereas divalent cationic species, preferably Li serve to create an even greater degree of crosslinking. Ca++ and Mg++ are less preferable due to their tendencies to rapidly form hydrates which often do not re-dissolve in the second phase of the reaction.

This material differs from geopolymers, in that, geopolymers consist of Al—O—Si networks and are generated via a one-step solvent-free method, and produce materials of vastly inferior strength. There is no carbon in the geopolymer matrix.

Geopolymers have been mixed with latex, acrylates, and ethylene vinyl acetate (hydrophilic hydrocarbon polymers). However, in these situations these polymers interface with the geopolymer only though a bridging O group via reduction of one of the polymer free hydroxyl or other electronegative reactive groups. There is no continuous integration of carbon into the geopolymer matrix itself, and the hydrocarbon polymer very much retains its molecular identity throughout the reaction and serves mainly as a stabilizer of what is a relatively flawed silyl-silanol condensation polymer.

Some geopolymers have been developed with unique porosity such that hydrocarbon containing or comprised molecules can be retained within them, thereby turning the geopolymer into a drug delivery mechanism. However, these compounds have no structural bonding to the geopolymer matrices, and thus are even farther from the presently disclosed invention than the geopolymer-glue materials previously mentioned. The case of geopolymers used in oilfields is similar in the ab/adsorption of carbon containing compounds onto/into the (porous) geopolymer in a fashion proportional to the surface area of the geopolymer particle.

Calcium Carbonate stabilized Aluminosilicates are significantly different from the present invention due their lack of a covalent C—Si bond formed in-reaction, if in fact they are in fact formed at all rather than simply being mined.

### EXAMPLES

The carbon compound(s), solvents, and alkaline solutions, with waterglass, are blended under agitator-level mixing conditions until a uniform solution is achieved. The dissolution of the carbon at room temperature is negligible, and as such the solution will be pitch black and gently roiling due to evaporative convection. As such, a lid should be placed on the vessel. As this stage, oligomerizing metallorganic materials may be added in trace quantities. These compounds, such as vinytrimethoxysilane serve to “seed” oligomeric structures which produce materials with differing strength, thermal, conductivity, and other properties. The solution may be heated in a pressure-sealed vessel to ensure dissolution of the materials. Upon cooling, remaining pressure may be released and excess solvent may need to be added. This breaching step is of importance to mention only since certain metallorganics evolve gasses in the presence of alkaline water. Organic polymer precursors, such as phenol and furan containing compounds, can be added at this step. The solution is best kept at cool temperatures.

The metal salt powder blend is prepared through the addition of Alumina as amorphous Al₂O₃ anhydrous, amorphous alkali silicoaluminate source such as low-calcined Kaolin clay or Spogumene, amorphous SiO₂ in the form of glass flour or fumed silica. It is also advantageous to add powdered LiOH or KOH to this powder mix to compensate for any neutralization of the solution previously disclosed through absorption of CO₂ into the solution. Once all powders have been combined, they must be put through a blending and de-agglomeration step, due to the anhydrous material's tendency to clump together. Once de-agglomerated and thoroughly blended, it should be sealed such that no moisture can access it.

Alternatively, recycled waste stream material may be added: aluminosilicate sources such coal combustion products (e.g. Fly Ash) or metal refining by products (ground blast furnace slag, silica fume), rice husk ash, municipal sludge ash, etc. In this case, the relative cationic concentrations must be carefully monitored and calculated and balanced. Alternatively, the Al₂ O₃ can be introduced to the liquid material.

According to these examples, approximately 90-95 grams of liquid is combined with 170-190 grams of the reactive powder mixture. The powder must be added to the liquid gradually or under very high shear to ensure forced reaction constituent proximity necessary to engage the first step of the reaction. If this directive is not followed, insufficient ‘wetting-out’ of the powder will occur, and the reaction will be ruined. If the mixing is occurring in a sealed kettle, the liquid component may be heated up to 60 degrees centigrade to aid in rapid dissolution and therefor hasten system throughput. Powdered caustic potash or LiOH will be of benefit as they will dissolve into the mixture as the hydrolysis of the amorphous reactive constituents consume the alkalinity of the system, maintaining a critical level of free C, Si, and Al ions.

This solution should be cooled and then undergo ultrahigh shear mixing, such as a rotostator pump or mixer, to ensure all reactive species have reacted. The more homogenous the solution/nanoslurry, and the less metallorganic oligomerizing agents present, the more amorphous the structure eventually formed will be. It is suggested that this step be cooled due to the excessive heat often generated by high shear systems. If a high shear mixer is lacking, a twin auger mortar mixer could suffice, though the mixing vessel ought to bathed in an ice bath.

Following high shear mixing, the solution/nanoslurry can have fibers and or other bulking and or functional additives placed into it. Due to the preference of the material for amorphous structures, glass fibers and carbon fibers may be added and expectedly produce a much stronger material than neat. Steel fibers are also an excellent choice due to their potential to be oxidized and form strong oxygen bridges with Al and Si, and rarely, oxycarbide groups. Alternatively, the slurry may be used to wet out a continuous fiber matrix. Any particulates added must be pre-wetted with a alkaline solution or they will destroy the viscosity of the material. Viscosity of the neat material can be altered through increasing the concentration of divalent cations over any monovalent cations present; the former form ionic stabilized gel that can reach the consistency of clay if so desired (e.g. extrusion). The recipes provided have roughly the consistency of cake batter, and may be injection cast or molded with ease. It manifests thixotropic behavior such that in-line vibration-aided de-airing would remove bubbles left in the matrix.

The material will take between 5 and 20 minutes to reach a demoldable state if left at the presumptively cooled state it was injected in. If the mold is heated, the demolding time can be decreased by a scale of magnitude, but care must be taken to ensure that proper solvent-moisture level is maintained in the matrix. This is not a difficult task, as the nano-porous nature of these particular mixtures makes them resilient to “dry out”.

Once demolded, the gel-state material is stable for 3 hours at room temperature at 20% humidity and 72° F. If refrigerated at 40 degrees, placed inside a non-porous/reactive plastic bag with water between pH 8 and 9, the gel state is stable for several days. At any point during this time, the material can be milled, tooled, etc. If the mixture is sufficiently de-aired, there will be minimal, though potentially noticeable under microscopic scrutiny, differences between the cast and the milled surfaces. This is largely determined by the tool used to mill the material.

The provided formulations are such that they are to be cured at saturated humidity between pH 2 and 10, 165° F., for 6 hours at least. Preferably 6 hours or more. Following that, the material should be allowed time to breathe for as long as possible before being put under maximum stress loads. This allows the remaining reaction solution to crystallize within the pores, creating a silicaceous polished surface appearance on the surface of the material. Depending on the solvent used and the level of dissolution of carbon compounds, this layer may or may not have different conductive properties than the primary matrices. Should the material be destined for metal casting applications, desiccation of the material would be advantageous to prevent the production of supercritical steam when the molten metal hits an improperly ‘breathed’ patch of the material.

It is noteworthy that the material does not seem to ever stop gaining strength, though the rate of strength gain does seem attenuate at a logarithmic rate. Nonetheless, several month old samples are significantly stronger than their younger counterparts. Materials of unprecedented strength could likely be obtained through curing regimes of several months.

First table below is example 1 and second table below is example 2.

When de-aired a bit, this is one that hit the demonstrated strength area

| | | | MW g/mol | | | | | |
|---|---|---|---|---|---|---|---|---|
| | | | 60 | 102 | 159.7 | 80 | 56 | 62 |
| | $/kg | amt (g) | SiO2 | Al2O3 | Fe2O3 | SO3 | CaO | Na2O |
| Ericson Coal Ash | $0.030 | | 38.8% | 20.1% | 6.3% | 1.2% | 22.0% | 2.3% |
| mass contribution | | | 0 | 0 | 0 | 0 | 0 | 0 |
| molar contribution | | | 0.00 | 0.00 | 0.00 | 0.000 | 0.00 | 0.00 |
| Recyc Amorphous C | $0.800 | 10.0 | 0% | 0.00% | 0.0% | 0.02% | 0.0% | 0% |
| mass contribution | | | 0 | 0 | 0 | 0.002 | 0 | 0 |
| molar contribution | | | 0 | 0 | 0 | 0.000025 | 0 | 0 |
| Monroe Coal Ash | $0.030 | | 42% | 22% | 8% | 1% | 16% | 1% |
| mass contribution | | | 0 | 0 | 0 | 0 | 0 | 0 |
| molar contribution | | | 0 | 0 | 0 | 0 | 0 | 0 |
| China Twp. Ash | $0.030 | | 37.90% | 19.8% | 5.9% | 2.60% | 16.30% | 7.75% |
| mass contribution | | | 0 | 0 | 0 | 0 | 0 | 0 |
| molar contribution | | | 0.00 | 0.00 | 0.00 | 0.00 | 0.00 | 0.00 |
| Steek Slag | $0.088 | | 35.83% | 10.8% | 0.5% | 3.06% | 40.43% | 0.25% |
| mass contribution | | | 0 | 0 | 0 | 0 | 0 | 0 |
| molar contribution | | | 0.00 | 0.00 | 0.00 | 0.00 | 0.00 | 0.00 |
| LF Steel Slag | $0.088 | 10.0 | 35.83% | 10.8% | 0.5% | 3.06% | 40.43% | 0.25% |
| mass contribution | | | 3.583 | 1.075 | 0.05 | 0.306 | 4.043 | 0.025 |
| molar contribution | | | 0.06 | 0.01 | 0.00 | 0.00 | 0.07 | 0.00 |
| Clay Ash | $0.600 | 50.0 | 53% | 45% | 0% | 0.1% | 0.1% | 0.1% |
| mass contribution | | | 2.64 | 22.3 | 0.2 | 0.05 | 0.05 | 0.05 |
| molar contribution | | | 0.44 | 0.2186 | 0.0013 | 0.0006 | 0.0009 | 0.0008 |
| Alumina (anhydrous) | $0.540 | 20.0 | 0.5% | 99.8% | 0.5% | 0.5% | 0.5% | 0.5% |
| mass contribution | | | 0.1 | 20.0 | 0.1 | 0.1 | 0.1 | 0.1 |
| molar contribution | | | 0.0 | 0.2 | 0.0 | 0.0 | 0.0 | 0.0 |
| Fume | $0.240 | 80.0 | 99.8% | 0% | 0% | 0% | 0% | 0% |
| mass contribution | | | 79.8 | 0.0 | 0.0 | 0.0 | 0.0 | 0.0 |
| molar contribution | | | 1.3 | 0.0 | 0.0 | 0.0 | 0.0 | 0.0 |
| G solid NaSiO2 | $1.736 | | 61.8% | 0% | 0% | 0% | 0% | 19.1% |
| mass contribution | | | 0.0 | 0.0 | 0.0 | 0.0 | 0.0 | 0.0 |
| molar contribution | | | 0.0 | 0.0 | 0.0 | 0.0 | 0.0 | 0.0 |
| PQ SOLID LithSil 2S | $4.400 | | 19.5% | 0% | 0% | 0.0% | 0.0% | 0.0% |
| mass contribution | | | 0 | 0 | 0 | 0 | 0 | 0 |
| molar contribution | | | 0.0 | 0.00 | 0.0 | 0.00 | 0.00 | 0.00 |
| LiOH monohydrate | $5.540 | 10.0 | 0.0% | 0% | 0% | 0% | 0% | 1% |
| mass contribution | | | 0.0 | 0.0 | 0.0 | 0.0 | 0.0 | 0.1 |
| molar contribution | | | 0.0 | 0.00 | 0.0 | 0.00 | 0.00 | |
| 50% NaOH solution | $0.500 | | 0.0% | 0.0% | 0.0% | 0.0% | 0.0% | 38.8% |
| mass contribution | | | 0.0 | 0.0 | 0.0 | 0.0 | 0.0 | 0.0 |
| molar contribution | | | 0.0 | 0.0 | 0.0 | 0.0 | 0.0 | 0.0 |
| 48% KOH solution | $0.640 | 47.0 | 0.0% | 0.0% | 0.0% | 0.0% | 0.0% | 0.0% |
| mass contribution | | | 0.0 | 0.0 | 0.0 | 0.0 | 0.0 | 0.0 |
| molar contribution | | | 0.0 | 0.0 | 0.0 | 0.00 | 0.00 | 0.00 |
| PQ “KSIL6” soln | $1.660 | | 26.6% | 0% | 0% | 0% | 0% | 0% |
| mass contribution | | | 0.0 | 0.0 | 0.0 | 0.0 | 0.0 | 0.0 |
| molar contribution | | | 0.0 | 0.00 | 0.0 | 0.00 | 0.00 | 0.00 |
| PQ NaSil “D” soln | $0.592 | | 29.8% | 0% | 0% | 0% | 0% | 14.7% |
| mass contribution | | | 0.0 | 0.0 | 0.0 | 0.0 | 0.0 | 0.0 |
| molar contribution | | | 0.0 | 0.00 | 0.0 | 0.00 | 0.00 | 0.00 |
| PQ NaSil “STAR” soln | $0.544 | 32.0 | 26.51% | 0.0% | 0.0% | 0.00% | 0.00% | 10.58% |
| mass contribution | | | 8.4832 | 0 | 0 | 0 | 0 | 3.3856 |
| molar contribution | | | 0.1 | 0.00 | 0.0 | 0.00 | 0.00 | 0.05 |
| PQ NaSil “M” soln | $0.552 | | 32.0% | 0.0% | 0.0% | 0.0% | 0.0% | 12.3% |
| mass contribution | | | 0.0 | 0.0 | 0.0 | 0.0 | 0.0 | 0.0 |
| molar contribution | | | 0.0 | 0.00 | 0.0 | 0.00 | 0.00 | 0.00 |
| PQ “D” soln | $0.592 | | 29.8% | 0.0% | 0.0% | 0.0% | 0.0% | 14.9% |

| | MW g/mol | | | | | |
|---|---|---|---|---|---|---|
| | 29.8 | 40.3 | 94 | 18 | 16.04 | % solids |
| | Li2O | MgO | K2O | H2O | CH4 | % ret. on 325 |
| Ericson Coal Ash | 0% | 0% | 0% | 0.1% | 0.0% | 6.75 |
| mass contribution | 0 | 0 | 0 | 0 | 0 | |
| molar contribution | 0 | 0 | 0 | 0.000 | 0.000 | |
| Recyc Amorphous C | 0% | 0% | 0% | 0.1% | 99.0% | 10.37 |
| mass contribution | 0 | 0 | 0 | 0.01 | 9.9 | |
| molar contribution | 0 | 0 | 0 | 0.0005556 | 0.617207 | |
| Monroe Coal Ash | 0.0% | 0% | 0% | 0% | 0% | 15.66 |
| mass contribution | 0 | 0 | 0 | 0 | 0 | |
| molar contribution | 0 | 0 | 0 | 0 | 0 | |
| China Twp. Ash | 0.0% | 4.0% | 0.98% | 0.10% | 0.00% | |
| mass contribution | 0 | 0 | 0 | 0 | 0 | |
| molar contribution | 0.00 | 0.00 | 0.00 | 0.00 | 0.00 | |
| Steek Slag | 0.0% | 10.5% | 0.36% | 1.75% | 0.00% | |
| mass contribution | 0 | 0 | 0 | 0 | 0 | |
| molar contribution | 0.00 | 0.00 | 0.00 | 0.00 | 0.00 | |
| LF Steel Slag | 0.0% | 10.5% | 0.36% | 1.75% | 0.00% | |
| mass contribution | 0 | 1.051 | 0.036 | 0.175 | 0 | |
| molar contribution | 0.00 | 0.03 | 0.00 | 0.01 | 0.00 | |
| Clay Ash | 0.0% | 0.1% | 1% | 1% | 0% | |
| mass contribution | 0 | 0.05 | 0.5 | 0.5 | 0 | |
| molar contribution | 0.0000 | 0.0012 | 0.0053 | 0.0278 | 0 | |
| Alumina (anhydrous) | 0.0% | 0.5% | 0.5% | 0.5% | 0.0% | |
| mass contribution | 0.0 | 0.1 | 0.1 | 0.1 | 0.0 | |
| molar contribution | 0.0 | 0.0 | 0.0 | 0.0 | 0.0 | |
| Fume | 0.0% | 0% | 0% | 0% | 0% | |
| mass contribution | 0.0 | 0.0 | 0.0 | 0.0 | 0.0 | |
| molar contribution | 0.0 | 0.0 | 0.0 | 0.0 | 0.0 | |
| G solid NaSiO2 | 0.0% | 0% | 0% | 18.5% | 0.0% | 80.9% |
| mass contribution | 0.0 | 0.0 | 0.0 | 0.0 | 0.0 | |
| molar contribution | | 0.0 | 0.0 | 0.0 | 0.0 | |
| PQ SOLID LithSil 2S | 2.3% | 0.0% | 0% | 0% | 0% | |
| mass contribution | 0 | 0 | 0 | 0 | 0 | |
| molar contribution | 0.00 | 0.00 | 0.00 | 0 | 0 | |
| LiOH monohydrate | 65.0% | 1% | 0.5% | 32.0% | 0.0% | |
| mass contribution | 6.5 | 0.1 | 0.1 | 3.2 | 0.0 | |
| molar contribution | 0.22 | 0.00 | 0.00 | 0.1777778 | 0 | |
| 50% NaOH solution | 0.0% | 0.0% | 0.0% | 61.2% | 0.0% | 38.80% |
| mass contribution | 0.0 | 0.0 | 0.0 | 0.0 | 0.0 | 0.0 |
| molar contribution | 0.0 | 0.0 | 0.0 | 0.0 | 0.0 | |
| 48% KOH solution | 0.0% | 0.0% | 37.2% | 62.8% | 0.0% | 37.24% |
| mass contribution | 0.0 | 0.0 | 17.5 | 29.5 | 0.0 | 17.5 |
| molar contribution | 0.00 | 0.00 | 0.19 | 1.6387333 | 0 | |
| PQ “KSIL6” soln | 0.0% | 0% | 12.7% | 60.7% | 0.0% | 39.30% |
| mass contribution | 0.0 | 0.0 | 0.0 | 0.0 | 0.0 | 0.0 |
| molar contribution | 0.00 | 0.00 | 0.00 | 0 | 0 | |
| PQ NaSil “D” soln | 0.0% | 0% | 0% | 55.5% | 0.0% | 44.54% |
| mass contribution | 0.0 | 0.0 | 0.0 | 0.0 | 0.0 | 0.0 |
| molar contribution | 0.00 | 0.00 | 0.00 | 0 | 0 | |
| PQ NaSil “STAR” soln | 0.0% | 0.0% | 0.00% | 62.9% | 0.0% | 37.09% |
| mass contribution | 0 | 0 | 0 | 20.1312 | 0 | 11.9 |
| molar contribution | 0.00 | 0.00 | 0.00 | 1.1184 | 0 | |
| PQ NaSil “M” soln | 0.0% | 0.0% | 0.0% | 55.6% | 0.0% | 44.37% |
| mass contribution | 0.0 | 0.0 | 0.0 | 0.0 | 0.0 | 0.0 |
| molar contribution | 0.00 | 0.00 | 0.00 | 0 | 0 | |
| PQ “D” soln | 0.0% | 0.0% | 0.0% | 55.3% | 0.0% | 44.69% |

When de-aired, this is the somewhere between basic and demonstrated strength mix
This is the formulation used to cast 2000f+ molten glass

| | | | MW g/mol | | | | |
|---|---|---|---|---|---|---|---|
| 66-86% | | | 60 | 102 | 159.7 | 80 | 56 |
| Recycled Content | $/kg | amt (g) | SiO2 | Al2O3 | Fe2O3 | SO3 | CaO |
| Ericson Coal Ash | $0.030 | 15.0 | 38.8% | 20.1% | 6.3% | 1.2% | 22.0% |
| mass contribution | | | 5.82 | 3.015 | 0.939 | 0.18 | 3.3 |
| molar contribution | | | 0.10 | 0.03 | 0.01 | 0.002 | 0.06 |
| Recyc Amorphous C | $0.240 | 15.0 | 0% | 0.00% | 0.0% | 0.02% | 0.0% |
| mass contribution | | | 0 | 0 | 0 | 0.003 | 0 |
| molar contribution | | | 0 | 0 | 0 | 3.75E−05 | 0 |
| Monroe Coal Ash | $0.030 | | 42% | 22% | 8% | 1% | 16% |
| mass contribution | | | 0 | 0 | 0 | 0 | 0 |
| molar contribution | | | 0 | 0 | 0 | 0 | 0 |
| China Twp. Ash | $0.030 | 100.0 | 37.90% | 19.8% | 5.9% | 2.60% | 16.30% |
| mass contribution | | | 37.9 | 19.8 | 5.9 | 2.6 | 16.3 |
| molar contribution | | | 0.63 | 0.19 | 0.04 | 0.03 | 0.29 |
| Steek Slag | $0.088 | | 35.83% | 10.8% | 0.5% | 3.06% | 40.43% |
| mass contribution | | | 0 | 0 | 0 | 0 | 0 |
| molar contribution | | | 0.00 | 0.00 | 0.00 | 0.00 | 0.00 |
| LF Steel Slag | $0.088 | 10.0 | 35.83% | 10.8% | 0.5% | 3.06% | 40.43% |
| mass contribution | | | 3.583 | 1.075 | 0.05 | 0.306 | 4.043 |
| molar contribution | | | 0.06 | 0.01 | 0.00 | 0.00 | 0.07 |
| Clay Ash | $0.600 | 5.0 | 53% | 45% | 0% | 0.1% | 0.1% |
| mass contribution | | | 2.64 | 2.23 | 0.02 | 0.005 | 0.005 |
| molar contribution | | | 0.044 | 0.0219 | 0.0001 | 0.0001 | 0.0001 |
| Alumina (anhydrous) | $0.340 | 30.0 | 0.5% | 99.8% | 0.5% | 0.5% | 0.5% |
| mass contribution | | | 0.2 | 29.9 | 0.2 | 0.2 | 0.2 |
| molar contribution | | | 0.0 | 0.0 | 0.0 | 0.0 | 0.0 |
| Fume | $0.160 | 2.0 | 99.8% | 0% | 0% | 0% | 0% |
| mass contribution | | | 2.0 | 0.0 | 0.0 | 0.0 | 0.0 |
| molar contribution | | | 0.0 | 0.0 | 0.0 | 0.0 | 0.0 |
| G solid NaSiO2 | $1.736 | | 61.8% | 0% | 0% | 0% | 0% |
| mass contribution | | | 0.0 | 0.0 | 0.0 | 0.0 | 0.0 |
| molar contribution | | | 0.0 | 0.0 | 0.0 | 0.0 | 0.0 |
| PQ SOLID LithSil 2S | $4.400 | | 19.5% | 0% | 0% | 0.0% | 0.0% |
| mass contribution | | | 0 | 0 | 0 | 0 | 0 |
| molar contribution | | | 0.00 | 0.00 | 0.0 | 0.00 | 0.00 |
| LiOH monohydrate | $5.540 | 10.0 | 0.0% | 0% | 0% | 0% | 0% |
| mass contribution | | | 0.0 | 0.0 | 0.0 | 0.0 | 0.0 |
| molar contribution | | | 0.0 | 0.00 | 0.0 | 0.00 | 0.00 |
| 50% NaOH solution | $0.500 | 45.0 | 0.0% | 0.0% | 0.0% | 0.0% | 0.0% |
| mass contribution | | | 0.0 | 0.0 | 0.0 | 0.0 | 0.0 |
| molar contribution | | | 0.0 | 0.0 | 0.0 | 0.0 | 0.0 |
| 48% KOH solution | $0.640 | | 0.0% | 0.0% | 0.0% | 0.0% | 0.0% |
| mass contribution | | | 0.0 | 0.0 | 0.0 | 0.0 | 0.0 |
| molar contribution | | | 0.0 | 0.0 | 0.0 | 0.00 | 0.00 |
| PQ “KSIL6” soln | $1.660 | | 26.6% | 0% | 0% | 0% | 0% |
| mass contribution | | | 0.0 | 0.0 | 0.0 | 0.0 | 0.0 |
| molar contribution | | | 0.0 | 0.00 | 0.0 | 0.00 | 0.00 |
| PQ NaSil “D” soln | $0.592 | 45.0 | 29.8% | 0% | 0% | 0% | 0% |
| mass contribution | | | 13.4 | 0.0 | 0.0 | 0.0 | 0.0 |
| molar contribution | | | 0.2 | 0.00 | 0.0 | 0.00 | 0.00 |
| PQ NaSil “STAR” soln | $0.544 | | 26.51% | 0.0% | 0.0% | 0.00% | 0.00% |
| mass contribution | | | 0 | 0 | 0 | 0 | 0 |
| molar contribution | | | 0.0 | 0.00 | 0.0 | 0.00 | 0.00 |
| PQ NaSil “M” soln | $0.552 | | 32.0% | 0.0% | 0.0% | 0.0% | 0.0% |
| mass contribution | | | 0.0 | 0.0 | 0.0 | 0.0 | 0.0 |
| molar contribution | | | 0.0 | 0.00 | 0.0 | 0.00 | 0.00 |

| | MW g/mol | | | | | |
|---|---|---|---|---|---|---|
| 66-86% | 62 | 29.8 | 40.3 | 94 | 18 | 16.04 |
| Recycled Content | Na2O | Li2O | MgO | K2O | H2O | CH4 |
| Ericson Coal Ash | 2.3% | 0% | 0% | 0% | 0.1% | 0.0% |
| mass contribution | 0.345 | 0 | 0 | 0 | 0.015 | 0 |
| molar contribution | 0.01 | 0 | 0 | 0 | 0.001 | 0.000 |
| Recyc Amorphous C | 0% | 0% | 0% | 0% | 0.1% | 99.0% |
| mass contribution | 0 | 0 | 0 | 0 | 0.015 | 14.85 |
| molar contribution | 0 | 0 | 0 | 0 | 0.0008333 | 0.9258105 |
| Monroe Coal Ash | 1% | 0.0% | 0% | 0% | 0% | 0% |
| mass contribution | 0 | 0 | 0 | 0 | 0 | 0 |
| molar contribution | 0 | 0 | 0 | 0 | 0 | 0 |
| China Twp. Ash | 7.75% | 0.0% | 4.0% | 0.98% | 0.10% | 0.00% |
| mass contribution | 7.75 | 0 | 4 | 0.98 | 0.1 | 0 |
| molar contribution | 0.13 | 0.00 | 0.10 | 0.01 | 0.01 | 0.00 |
| Steek Slag | 0.25% | 0.0% | 10.5% | 0.36% | 1.75% | 0.00% |
| mass contribution | 0 | 0 | 0 | 0 | 0 | 0 |
| molar contribution | 0.00 | 0.00 | 0.00 | 0.00 | 0.00 | 0.00 |
| LF Steel Slag | 0.25% | 0.0% | 10.5% | 0.36% | 1.75% | 0.00% |
| mass contribution | 0.025 | 0 | 1.051 | 0.036 | 0.175 | 0 |
| molar contribution | 0.00 | 0.00 | 0.03 | 0.00 | 0.01 | 0.00 |
| Clay Ash | 0.1% | 0.0% | 0.1% | 1% | 1% | 0% |
| mass contribution | 0.005 | 0 | 0.005 | 0.05 | 0.05 | 0 |
| molar contribution | 0.0001 | 0.0000 | 0.0001 | 0.0005 | 0.0028 | 0 |
| Alumina (anhydrous) | 0.5% | 0.0% | 0.5% | 0.5% | 0.5% | 0.0% |
| mass contribution | 0.2 | 0.0 | 0.2 | 0.2 | 0.2 | 0.0 |
| molar contribution | 0.0 | 0.0 | 0.0 | 0.0 | 0.0 | 0.0 |
| Fume | 0% | 0.0% | 0% | 0% | 0% | 0% |
| mass contribution | 0.0 | 0.0 | 0.0 | 0.0 | 0.0 | 0.0 |
| molar contribution | 0.0 | 0.0 | 0.0 | 0.0 | 0.0 | 0.0 |
| G solid NaSiO2 | 19.1% | 0.0% | 0% | 0% | 18.5% | 0.0% |
| mass contribution | 0.0 | 0.0 | 0.0 | 0.0 | 0.0 | 0.0 |
| molar contribution | 0.0 | | 0.0 | 0.0 | 0.0 | 0.0 |
| PQ SOLID LithSil 2S | 0.0% | 2.3% | 0.0% | 0% | 0% | 0% |
| mass contribution | 0 | 0 | 0 | 0 | 0 | 0 |
| molar contribution | 0.00 | 0.00 | 0.00 | 0.00 | 0 | 0 |
| LiOH monohydrate | 1% | 65.0% | 1% | 0.5% | 32.0% | 0.0% |
| mass contribution | 0.1 | 6.5 | 0.1 | 0.1 | 3.2 | 0.0 |
| molar contribution | | 0.22 | 0.00 | 0.00 | 0.1777778 | 0 |
| 50% NaOH solution | 38.8% | 0.0% | 0.0% | 0.0% | 61.2% | 0.0% |
| mass contribution | 17.5 | 0.0 | 0.0 | 0.0 | 27.5 | 0.0 |
| molar contribution | 0.3 | 0.0 | 0.0 | 0.0 | 1.5 | 0.0 |
| 48% KOH solution | 0.0% | 0.0% | 0.0% | 37.2% | 62.8% | 0.0% |
| mass contribution | 0.0 | 0.0 | 0.0 | 0.0 | 0.0 | 0.0 |
| molar contribution | 0.00 | 0.00 | 0.00 | 0.00 | 0 | 0 |
| PQ “KSIL6” soln | 0% | 0.0% | 0% | 12.7% | 60.7% | 0.0% |
| mass contribution | 0.0 | 0.0 | 0.0 | 0.0 | 0.0 | 0.0 |
| molar contribution | 0.00 | 0.00 | 0.00 | 0.00 | 0 | 0 |
| PQ NaSil “D” soln | 14.7% | 0.0% | 0% | 0% | 55.5% | 0.0% |
| mass contribution | 6.6 | 0.0 | 0.0 | 0.0 | 25.0 | 0.0 |
| molar contribution | 0.11 | 0.00 | 0.00 | 0.00 | 1.3865 | 0 |
| PQ NaSil “STAR” soln | 10.58% | 0.0% | 0.0% | 0.00% | 62.9% | 0.0% |
| mass contribution | 0 | 0 | 0 | 0 | 0 | 0 |
| molar contribution | 0.00 | 0.00 | 0.00 | 0.00 | 0 | 0 |
| PQ NaSil “M” soln | 12.3% | 0.0% | 0.0% | 0.0% | 55.6% | 0.0% |
| mass contribution | 0.0 | 0.0 | 0.0 | 0.0 | 0.0 | 0.0 |
| molar contribution | 0.00 | 0.00 | 0.00 | 0.00 | 0 | 0 |

The composition formed is an amorphous polymer of silicon and aluminum with carbon and oxygen bonds. Raman spectroscopy is one way to measure the amorphous nature and observe the bonds present. Crystalline materials exhibit relatively shape bands and harmonic repetition of bands. The inventive materials are characterized by wide diffuse bands with a lack of harmonics. The silicon oxygen bridge between 1300 and 1400 wave numbers in the instant samples have a full width half height normalized ration from 0.12 to 0.16.

Proppants are materials that are injected into hydraulically fractured oil and gas wells to “prop open” the fissures that are created during fracturing. Proppants must be transportable through injection media to the fissures, deposit appropriately throughout the fissure, and be strong enough not to “crush” under pressure from the walls of the fissure. They must also have a spherical geometry that creates a porous bed for the released oil and gas to permeate through the proppant (called ‘conductance’), and be collected at the well's surface. Today's proppants are typically sand, coated sand, clay-based ceramics (intermediate grades are the vast portion of the market), or sintered bauxite (high-value proppants).

Examples were made according to the method of example 1 with the starting materials:

| Grams | Grams | Grams Carbon | Grams | Grams Part B |
|---|---|---|---|---|
| Al(OH)3 | SiO2 | Black | MgO | (pH 13.4) |
| 33.43 | 42.78 | 3.86 | 1.66 | 43.3 |

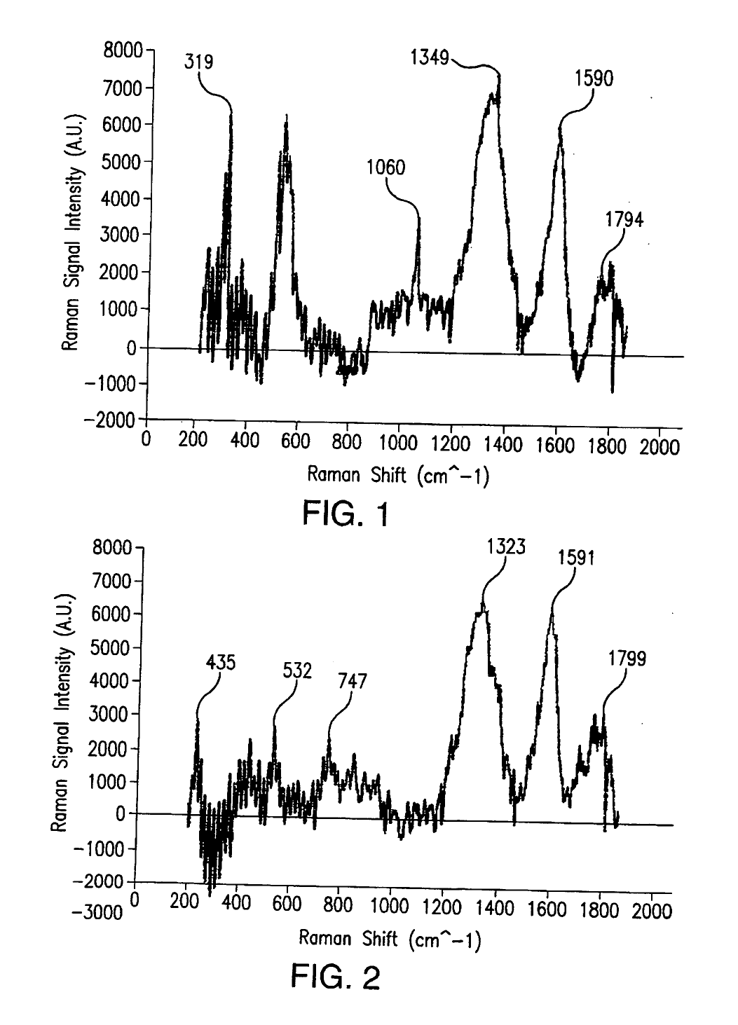

Part B is a solution of 20 g KOH 112 grams water glass, 20 g amorphous silicon, 12.5 grams methanol, 12.5 grams methylene glycol, and 4 grams formic acid. The Al(OH)₃, SiO2, Carbon and MgO were mixed as dry powder, then added with mixing to part B solution. The slurry was allowed to green set for 30 minutes, followed by curing in a 160 degree Fahrenheit oven for 12 hours. The cure step for example 3 being in air at 30% humidity and the cure step for example 4 in air at 100% humidity. Example 3 Raman peak at 1349 wave numbers (cm⁻¹) has a full width half height ratio of 0.12. (See FIG. 1) Example 4 Raman peak at 1323 wave numbers (cm⁻¹) full width half height ratio is 0.16. (See FIG. 2)

In addition to the HCPC's versatility in terms of manufacturing parts and components from the material itself, the material also has several applications for use in the metal casting industry. The chemical inertness and temperature resistance of the material to 3400° f allows it to be used to cast both nonferrous and ferrous metals and metal alloys. Due to its high dimensional stability at high temperatures and low reactivity, the material could allow a disruptive innovation in allowing steel to be die cast, currently impossible by conventional means. The tailorable thermal conductivity of the material is of especially great interest for aluminum casting; the faster the aluminum cools from molten to glassy state, the more amorphous the structure and the harder the resulting part. The quickest entry into the market is somewhat less glamorous: pattern casting material for medium to high volume sand casting operations. In these operations, sand is blown and/or pressed against a urethane pattern which are typically cast off of metal master. There is a need for a pattern casting material with higher abrasion resistance than urethane, and that can withstand the heat of hot sand mold making, rather than the cold sand required by the thermally labile urethanes. Hot sand making of molds allows considerably more rapid mold creation than cold sand methods.

The HCPC has several readily apparent dimensions of appeal: Its composition can be composed of available refined feedstocks, and can optionally include various quantities of USA-sourced technical grade postindustrial waste stream materials, offsetting both bulk material costs and decreasing environmental impact of formulation. It contains no formaldehyde, VOC's, or heavy metals, thus mitigating personnel safety risk. It is potentially amenable to 3D-printing based rapid prototyping and fabrication methodologies; applications include rapid production of both part and molds. When used as a mold, the HCPC material can be tooled quickly in gel state, thereby minimizing machine time and labor expenses. If used as a mold, its high temperature stability and thermal conductivity allows for fast demold times of both cast metals, and sequentially, thermoset/plastics. The same mold can be used to cast multiple material types, including Li—Al alloys, Steel, and as well as organic polymers.

These properties will allow the HCPC material to fulfill several material needs, which include high temperature structural component requirements that do not delaminate or crack, the need for fast turn-around time production methodologies and cross-material scalable design process, the need for low-cost high precision components at medium production scale, the need for ablative/reusable heat shielding, the need for advancements in cast metal process and associated materials, among others. Due to high dimensional stability, the HCPC material can also be used to make molds for casting titanium, steel, as well as lithium-aluminum alloys, and more.

When used as a viscous coating and patch-cured, our HCPC provides a highly temperature resistant, dimensionally stable, hydrophobic, thermal shock resistant coating with tunable electromagnetic absorption/conduction properties and high substrate bond strength. This coating can be applied at room temperature, contains no VOC's, and is environmentally friendly. Low deployment cost and increased durability decreases cost of production and sustainment for current and future LO material coated systems.

The materials of this invention have a lot of potential uses, including: dental implants and plating; speaker housings, bracings, passive/active absorbing interfaces, braces mounts, transducer component; synthetic decking, flooring, and tiling; “ceramic” preforms for investment casting; metal casting molds, cored, dies, patterns, and forms; precast building elements, load bearing and decorative; disc brakes, brake pads, bearings, rotary gaskets; glassblowing molds, pads, handles, tongs, forms, and others; dishware, drinking glasses/cups, plates, platters, bowls; adhesives, coatings, varnish, veneer, polish, stain, colorant; refractory cauldrons, kiln walls, molds, flooring; watch housings, belt buckles, buttons, cufflinks; building compound/binder (cement), bricks, highway sleepers, sidewalk slabs; grills, griddles, smokehouses, cookers, autoclaves; resistive heating elements, thermoelectric components; cast metal tooling and substrate; interleaved metal/ceramic products; cermets; solid surfaces such as countertops, bathroom sinks/basins, hot tubs, pools; performance flooring, roofing (continuous), tiles, extruded roofing plates; drivetrain: transaxle, engine components, front drive axle, drive shaft, rear drive axle, rear differential, and engine components; gears, sprockets, bolts, nuts, brackets, pins, bearings, cuffs; engine blocks, fly wheels, turbo fans, compression housings, fuel line connectors; turbine vanes, blades, rotary cores, ignition chambers, exit valves, guide nozzles; drilling shafts, well shield/walls, drill bits; aerospace interiors, arm rests walls, shelves, brackets and more; valves, pump housings, rotors; preforms for glass-to-metal seal; deep drilling rig, teeth, pylons, shaft, related equipment components; bricks, cinderblocks, speed bumps, flooring tiles; battery anode, cathode, housing; plug-in hybrid electric vehicle components, EMF shielding; wheel hubs and components; artificial limb and joint apparatus components; lighting housing, filament, base, bulb components; marine system components and hulls; biological sample gathering and treatment; basins, bowls, and vessels; heat radiation substrate; boats and boat parts; car and car parts; heat/abrasive/caustic/acidic material resistant pipes and linings; fluid and gas tanks; nozzles, bell jars, magnets, blades and abrasives, telecommunications relays, magnetrons, circuits; rings; general health care applications not otherwise mentioned; thermal and electric insulators; covers; microelectronic applications not otherwise mentioned, precast building elements, cast in place building elements, and structural elements applications not otherwise mentioned. Appliance housings, autobody interior and exterior paneling, bridge building and other distance spanning structural components. 3D printed components, structures, process, and elements. Electrical discharge machining heads and other components. “appliance” as in consumer appliance housings, “bridge,” and “autobody” for paneling.

Other possible applications are for prostheses, medical implants, countertops and labtops, consumer electronic housings, industrial and commercial flooring, can coatings, tank linings, pipe coatings and linings, re-bar, EDM milling electrode, and EDM milled parts. The materials of this invention can be used as coatings for various substrates, such as, for example, metals.

What is claimed is:

1. A composition of matter comprising:
a polymer of aluminum, silicon, carbon, and oxygen.

2. A composition of matter provided by the incipient materials:
a. aluminum oxide,
b. silicon oxide,
c. carbon, and, a source of
d. divalent cations.

3. A composition of matter as claimed in claim 2 wherein the composition of matter is a gel.

4. The composition as claimed in claim 2 wherein the divalent cations are selected from the group consisting of calcium, and magnesium.

5. A composition of matter as claimed in claim 2 wherein, in addition, metal is added.

6. A composition of matter as claimed in claim 2 wherein, in addition, fibers are added.

7. A composition of matter as claimed in claim 2 wherein, in addition, other metallic oxides are added.

8. A method of preparation of a composition of claim 1, said method comprising:
a. providing a mixture of aluminum oxide and silicon oxide;
b. providing a mixture, having a basic pH, in a slurry form, of
i. water,
ii. a source of OH⁻,
iii. carbon, and,
iv. a source of divalent cations;
c. mixing A. and B. together using shear force to form a stiff gel;
d. exposing the product of C. to a temperature in the range of 160° F. to 250° F. for a period of time to provide a thermoset ceramic.

9. The method as claimed in claim 8 wherein the temperature range is from 175° F. to 225° F.

10. The method as claimed in claim 8 wherein the time period for heating is 2 to 6 hours.

11. The method as claimed in claim 8 wherein the time period of heating is in excess of 6 hours.

12. A product when prepared by the method as claimed in claim 8.

13. A method of hydraulically fracturing oil and gas wells, said method comprising using the composition as claimed in claim 2 as the proppant.

14. A solid substrate when coated with a composition as claimed in claim 2.

15. A composition of matter consisting of amorphous polymer comprising metal carbon bonds and metal oxide bonds.

16. A composition as claimed in claim 15 wherein the ratio of metal carbon bonds to metal oxygen bonds is 0.1-1:1.

17. A composition as claimed in claim 15 wherein the metals consist of silicon and aluminum.

18. A composition as claimed in claim 15 wherein the amorphous nature is exhibited by a Raman metal oxide peak between 1300 and 1400 wavenumbers half height full width ratio of greater than 0.1.

19. A composition as claimed in claim 18 wherein the half height full width ratio is greater than 0.12.
